(19) United States
(12) Patent Application Publication
(10) Pub. No.: US 2006/0068779 A1
(43) Pub. Date: Mar. 30, 2006

(54) Roaming of mobile radio units in a multicast digital network

(76) Inventor: Rex Allen Nisbet, Christchurch (NZ)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/232,716

(22) Filed: Sep. 22, 2005

Related U.S. Application Data
(60) Provisional application No. 60/613,748, filed on Sep. 27, 2004.

(30) Foreign Application Priority Data
Sep. 22, 2004 (NZ) 535471

(51) Int. Cl. H04Q 7/20

(52) U.S. Cl. 455/432.1; 455/434; 455/518

(57) ABSTRACT

During idle periods in a non trunked mobile radio network, the base stations periodically transmit a channel-marking signal. While the channel-marking signal is being transmitted base stations in the same “channel”, with adjacent coverage areas, announce information about the base station sending the channel-marking signal. Following the base station announcements, each mobile station checks the transmit frequency of the adjacent base station. If the signal from the adjacent base station is stronger than the signal from the base station to which the mobile was previously tuned, the mobile remains tuned to the new transmit frequency. Otherwise the mobile re-tunes to the original frequency.

### FIELD OF THE INVENTION

This invention relates to roaming of mobile units in a digital radio network, in particular but not only to movement of individual mobile units between adjacent base sites in a multicast network during a group call involving multiple units.

### BACKGROUND TO THE INVENTION

Digital radio networks can be either trunked or non trunked. In a trunked network, a mobile unit communicates with a local base station via a control channel to set up a call, and is allocated a traffic channel from the range of local channels that are available at the time. Non trunked or “conventional” networks typically involve either simulcast or multicast operation. In a simulcast call, all of the base stations and mobile units in a particular call use a channel having a common frequency. Multicast calls typically involve different channel frequencies at each base station.

Multi-cast networks offer many of the advantages of simulcast networks but are considerably simpler than simulcast networks. This simplicity is at the cost of greater RF spectrum use and increased channel access (call set up) time. Networks of this type are common among Public Safety services in New Zealand and Australia. Some users in North America have also shown interest for use of multicast systems in developing APCO P25 networks. The channel access time can result in lost speech, which is undesirable for users.

Typical multi-cast conventional networks operate as follows: The network consists of one or more “channels”. Each “channel” consists of a number of base stations each at a different location. Each base station has a dedicated transmit frequency. The base stations making up a “channel” often share a common receive frequency. The mobile stations using a “channel” transmit on the common base station receive frequency. A voter function in the network selects the best base station to receive the mobile. Audio from dispatch consoles or received from mobile stations is transmitted by all the base stations for a particular “channel”. The mobile station receivers scan the base station transmit frequencies. When the base stations begin transmitting each mobile locks-on to the base station with the best signal. It is this scanning and lock on process that causes the channel access delay.

If operation as described above is implemented in a P25 network, the delays can be considerably longer due to the frame structure of P25. Encryption could increase the channel access delay further if the encryption control information is missed due to scanning.

Some multicast type networks have all base stations continuously transmitting in order to speed up the voting process. However this has several drawbacks. The time to vote is still long enough that critical parts of the P25 signal will be missed leading to significant lost speech. All base stations continuously transmitting significantly increases the power used by the base stations this may be unacceptable on solar powered installations. Continuously receiving a signal from base stations may defeat the power saving strategies of portable stations using the network. When neighboring networks re-use the same frequencies mobile stations sometimes lock on to the wrong network.

The term “base station” in this specification includes a “repeater”. The term “base site” includes reference to one or more base stations that serve mobile units within a limited geographical area. In some networks each base site includes a local controller and the network is operated by cooperation between the controllers to provide “distributed control”. Some networks may include a “central controller” located at a specific base site or at a non C radio site, to coordinate operation of the base sites. Still other networks may include aspects of both distributed and central control.

### SUMMARY OF THE INVENTION

It is an object of the invention to reduce channel access time during movement of mobile units in multicast conventional networks, or at least to provide useful alternatives for existing networks of this general kind.

In one aspect the invention may broadly be said to consist in a method of assisting a mobile unit in a radio network, including: transmitting a first assist signal from a first base station in the network, transmitting a second assist signal from a second base station adjacent the first station, containing information about the first base station, assessing the first and second assist signals at a mobile unit that is served by the second station, and continuing service for the mobile unit without change of base station, or changing service for the unit from the second to the first station, in accord with the assessment.

Preferably the method further includes: transmitting multiple second assist signals from respective second base stations adjacent the first base station, each containing information about the first station, assessing the first and second assist signals at mobile units that are served by respective second base stations, and continuing service for each of the mobile units without change of base station, or changing service for each unit from the respective second station to the first station, in accord with the respective assessment.

Preferably the method further includes: determining that the first base station is idle before commencing transmission of the first assist signal.

Preferably the method further includes: buffering other transmissions from the first and second base stations while transmitting the first and second assist signals.

In general the mobile unit is participating in a call with a group of other mobile units served by a multicast system in the network. In other embodiments mobiles not participating in the call may also use the method to change service between base stations.

Preferably the method further includes: monitoring radio traffic flow at each base station involved in the call, and selecting the first base station as a station that has become idle.

Preferably the method further includes: buffering transmissions received from each mobile station in the group while the first base station is transmitting the first assist signal.

Preferably the method further includes: transmitting a commencement signal to each base station adjacent to the first base station before transmitting the first assist signal from the first base station, and transmitting a second assist signal from each base station adjacent to the first base station for a predetermined period of time after receipt of the commencement signal.

Preferably the method further includes: monitoring all group calls between mobile units in the network, and selecting one or more first base stations for transmission of a respective assist signal according to radio traffic flow in the groups.

In general the mobile unit assesses the assist signals using error rate, received signal strength or noise characteristics.

In a further aspect the invention consists in a method of moving a mobile unit between base sites during a group call in a radio network, including: receiving an assist signal from a base station at a base site currently serving the mobile unit, determining from the assist signal another base station in a base site adjacent to the site currently serving the mobile unit, receiving an assist signal from the other base station in the adjacent base site, and comparing the assist signals to determine whether or not to continue service from the current base site or to switch service to the adjacent base site.

Preferably the method further includes: comparing the assist signals using error rate, received signal strength or noise characteristics of the signals.

In a still further aspect the invention may be said to consist in a radio network including: a plurality of base stations each located at a respective base site, and a central controller that coordinates multicast group calls among mobile units that are served by the stations, and assists movement of the units between base sites during calls, wherein the controller monitors radio traffic flows at each base station serving a common group call, instructs transmission of a first assist signal by a first base station that serves the call, and instructs transmission of one or more second assist signals by respective second stations that serve the call and are in sites adjacent the first station.

In general the controller may instruct the first and second base stations to transmit the first and second assist signals for a predetermined period of time after the first station becomes idle during the call.

In general, mobile units receiving service from each of the second stations assess both the first assist signal and their respective second assist signals to determine whether or not to transfer service from the respective second station to the first station.

In a further aspect the invention may be said to consist in a base site in a radio network, including: a base station that provides group call services to mobile units located within the site, and a controller that monitors traffic flow through the base station and assists movement of mobile units into the site during a group call, wherein the controller instructs the base station to transmit a first assist signal when the station becomes idle, and instructs base stations serving the call at adjacent base sites to transmit respective second assist signals simultaneously with the first assist signal.

In general, the controller assists movement of mobile units into the site during the group call by instructing the base station to transmit a second assist signal when requested by a controller at an adjacent site.

The method can be extended for use by mobile units whether or not they are participating in a particular call.

The invention also consists in any alternative combination of features that are indicated in this specification. All alternatives to these features are deemed to be included whether or not explicitly set out.

### LIST OF FIGURES

Preferred embodiments of the invention will be described with reference to the accompanying drawings, of which:

FIG. 1 schematically shows mobile units participating in a group call in a radio network with distributed control,

FIG. 2 schematically shows mobile units participating in a group call in a radio network with central control,

FIG. 3 indicates a message sequence between base stations in a network with distributed control,

FIG. 4 indicates a message sequence between base stations in a network with central control,

FIG. 5 outlines operation of a base station sending a channel mark signal in a network with distributed control,

FIG. 6 outlines operation of a base station sending a channel mark signal in a network with central control,

FIG. 7 outlines operation of a controller coordinating a channel mark signal in a network with central control,

FIG. 8 outlines operation a base station receiving a scan assist message in a network having either distributed or central control,

FIG. 9 outlines operation of a mobile unit when assessing signals from adjacent sites, and

FIG. 10 is an example indicating timing of messages in a network having distributed control.

### DETAILED DESCRIPTION OF PREFERRED EMBODIMENTS

Referring to the drawings it will be appreciated that the invention may be implemented in many different ways for a range of different radio networks. The embodiments described here are given by way of example only. The structure and operation of conventional radio networks, multicasting and P25 will also be well known to a skilled reader and need not be described in detail.

While the network is idle the base stations periodically transmits a channel-marking signal such as a stream of P25 terminator data units. At the same time as the channel-marking signal is being transmitted base stations in the same “channel”, with adjacent coverage areas announce information about the base station sending the channel-marking signal. The P25 adjacent site broadcast link control word sent within a P25 extended terminator data unit could be used for this purpose.

Following the base station announcement, each mobile station checks the adjacent base station's transmit frequency. If the adjacent base station's signal is stronger than the base station the mobile was previously tuned to the mobile remains tuned to the new base stations transmit frequency. Otherwise the mobile re-tunes to its original frequency.

Because the mobile stations only check one other base station which is already transmitting at full power, the time that the mobile is unable to receive user traffic is much shorter than would be the case for the complete scan and vote process in existing systems. Because the network triggers the checking process and can be programmed with the maximum time needed by the mobiles stations to check an adjacent site, the network knows the window when mobiles will be unable to receive traffic. The network can therefore take action to prevent traffic being lost during this window. This window is likely to be a few 10s of milliseconds.

The preferred method is for base stations serving mobiles that are in the process of checking adjacent sites to buffer speech during the vote window. The base stations sending the adjacent site info start a timer when the base station sends information about an adjacent site. The duration of the timer is the maximum time that a mobile station takes to check an adjacent site. The network then buffers any traffic until the timer expires.

The base station sending the marking signal must also refrain from sending user traffic during the time that mobiles from other sites maybe switching to it. In this case the window when traffic is not transmitted is different. It starts when the base station starts sending the marking signal and finishes when the mobile stations from adjacent sites are ready to receive on the marked frequency. This window does not extend until the mobile stations have had time to return to their original frequency. Again the network buffers the traffic.

Alternatively during this process all base stations inhibit inbound transmissions from mobile stations. This could be done using the busy status symbols in the P25 stream for example.

Co-ordination of the channel-marking signal, announcements and traffic buffering can either be by a centralized controller within the network or by a distributed procedure amongst the base stations. Mobile stations can therefore select a good base station before a voice transmission starts so no speech is lost.

This idea can be extended so that during a speech transmission, mobile stations that are not parties to that transmission check adjacent base stations during the transmission. The adjacent site information could be carried in P25 the link control words.

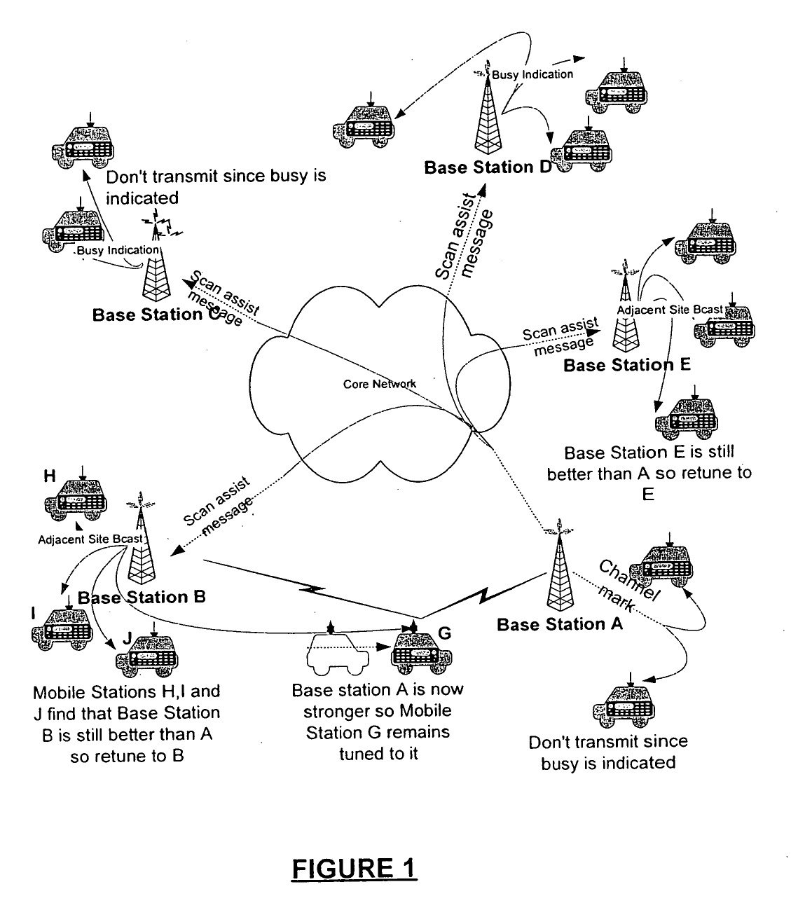

FIG. 1 schematically indicates a radio network with distributed control using multicast transmission between mobile units in a group call. Base station A sends a Scan Assist message via the core network to the other base stations that handle the same user traffic. Base station A also sends a channel-marking signal on its RF interface. In response to the scan assist message base stations B and E send adjacent site broadcasts announcing base station A.

Mobile station G receives the adjacent site broadcast from base station B. Mobile station G has recently moved closer to base station A. When it switches to Base Station A's operating frequency, mobile station G finds that the channel-marking signal signal from Base station A is better than the signal from Base station B. Mobile station G therefore remains tuned to the Base Station A's operating frequency.

Mobile stations H, I and J also receive the adjacent site broadcast from base station B but find that the signal from base station A is not as good as the signal from base station B, so retune back to base station B. Base Stations C and D are not adjacent to Base station A so need not send the adjacent site broadcast but they must send a signal that carries the busy indication. Since all sites send a busy indication no mobile can transmit until all other mobiles have had time to check base station A and if it is not satisfactory return to their original base stations.

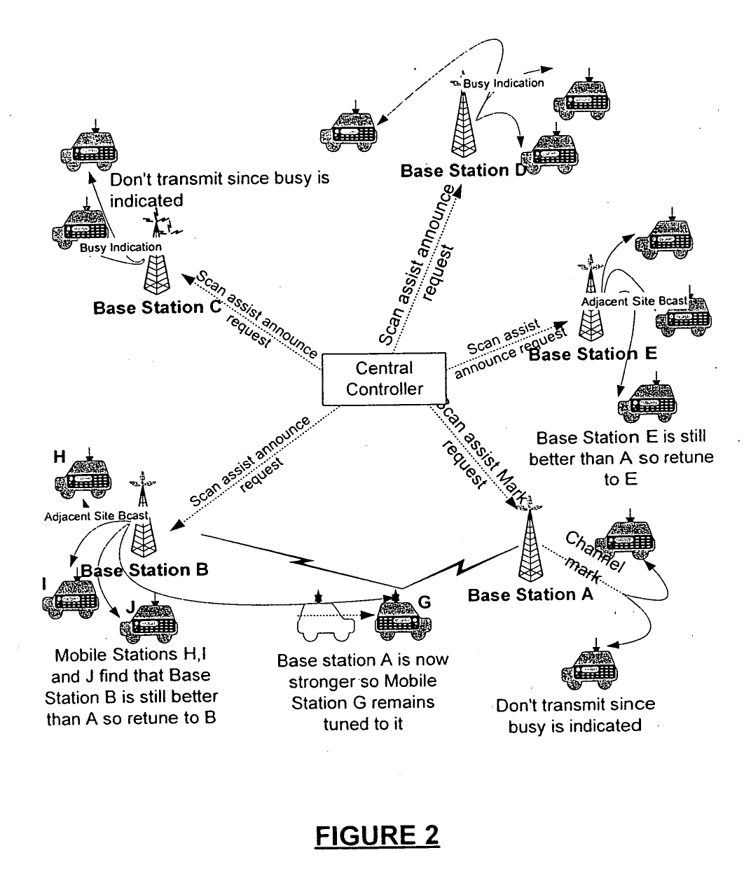

FIG. 2 schematically indicates a radio network with central control using multicast transmission between mobile units in a group call. The operation is broadly similar to FIG. 1 except that the central controller coordinates the various scan assist processes. The controller monitors each call in progress on the network, being calls between two units or groups of units. When a base station serving mobile units in a call becomes idle, such as station A in this example, the controller may send a mark request message to the station. Announce request messages are simultaneously sent to the other stations, similarly to the assist messages sent by station A in FIG. 1. Station A then transmits the channel marking signal while adjacent stations B and E send announcement messages. Other stations such as C and D generally send a busy indication.

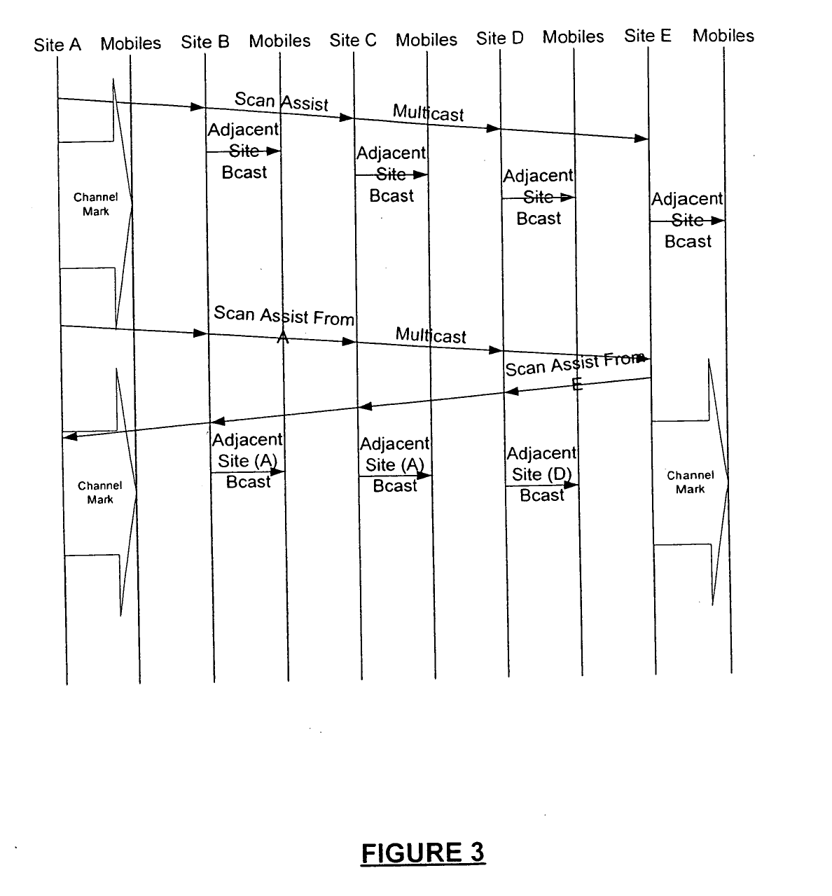

FIG. 3 indicates a sequence of messages in a network with distributed control of the scan assist process described in relation to FIG. 1. Station A (at site A) determines an appropriate time to commence channel marking and sends scan assist messages to each of stations B, C, D and E (at respective sites) by multicast. Station A then commences transmission of the channel marking signal while the stations adjacent to A transmit announcement messages. If two base stations such as A and E initiate the scan assist process at about the same time some base stations will announce one adjacent site while others will announce the other. Since each base station has a different delay between scan assists so the next scan assist by each will be acted on by all the adjacent site base stations.

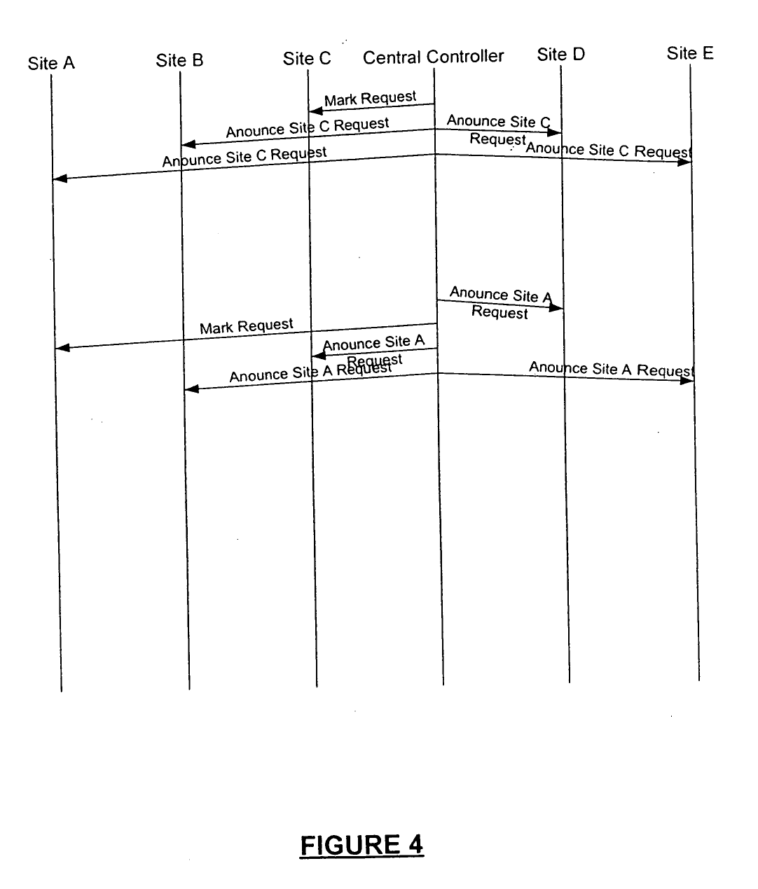

FIG. 4 indicates a sequence of messages in a network with central control of the scan assist process described in relation to FIG. 2. The central controller instructs station C (site C) to commence channel marking, typically because the station is currently idle in a call. The other stations involved in the call are instructed to transmit announcement messages. Station A is subsequently instructed to commence channel marking while the other stations are instructed to transmit announcement messages.

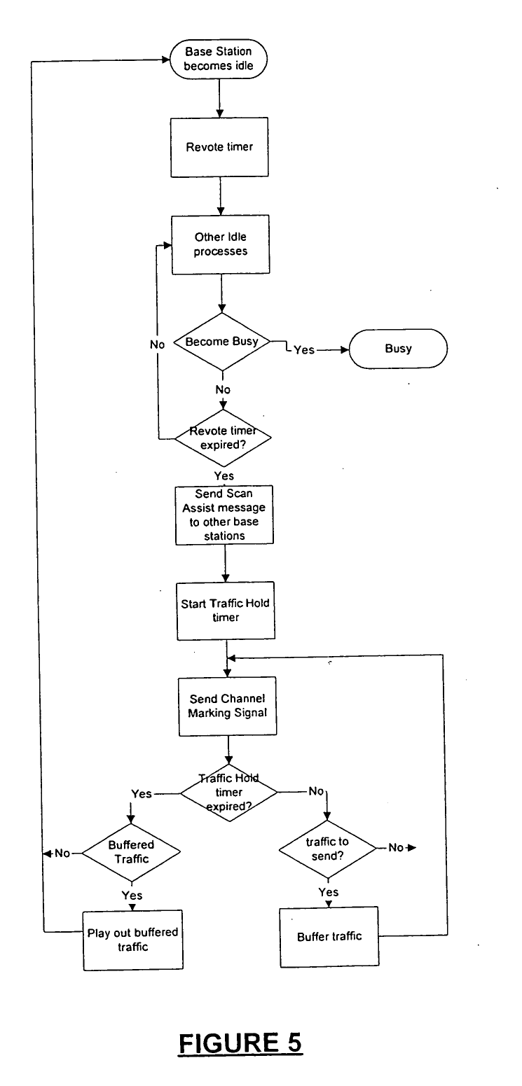

FIG. 5 outlines the operation of a base station sending a channel marking signal in a network with distributed control, such as station A in FIG. 1. The station becomes idle during a call and initially carries out other prescribed idle processes for period of time. If the station is still idle it sends scan assist messages to other base stations and commences transmission of the marking signal for a predetermined period. Traffic received from local mobiles or elsewhere during the marking period is buffered and sent after the marking process has ended. Similarly any scan assist messages received from other base stations will be ignored during this time.

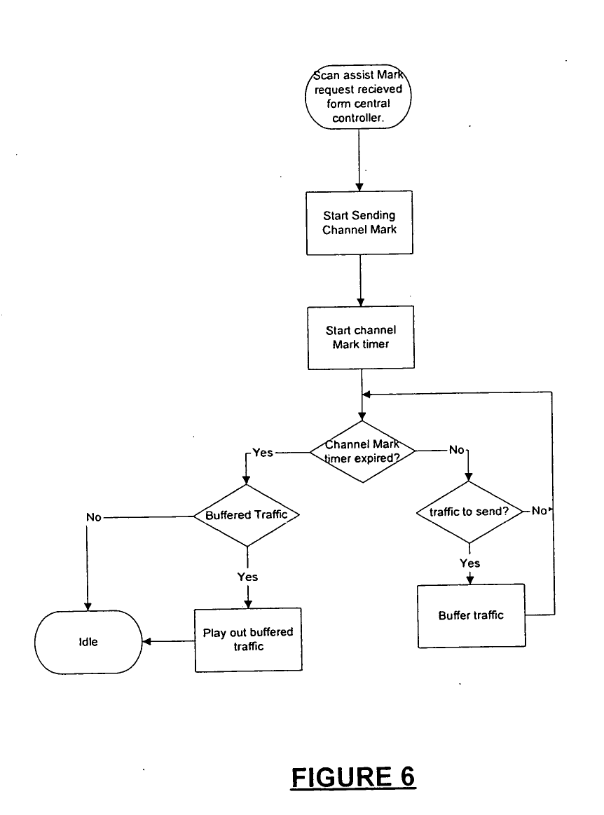

FIG. 6 outlines the operation of a base station sending a channel marking signal in a network with central control, such as station A in FIG. 2. The station first receives an instruction from the central controller and commences transmission of the marking signal. The signal is sent for a predetermined duration during which other incoming or outgoing traffic is buffered and resumed once the scan assist process is complete.

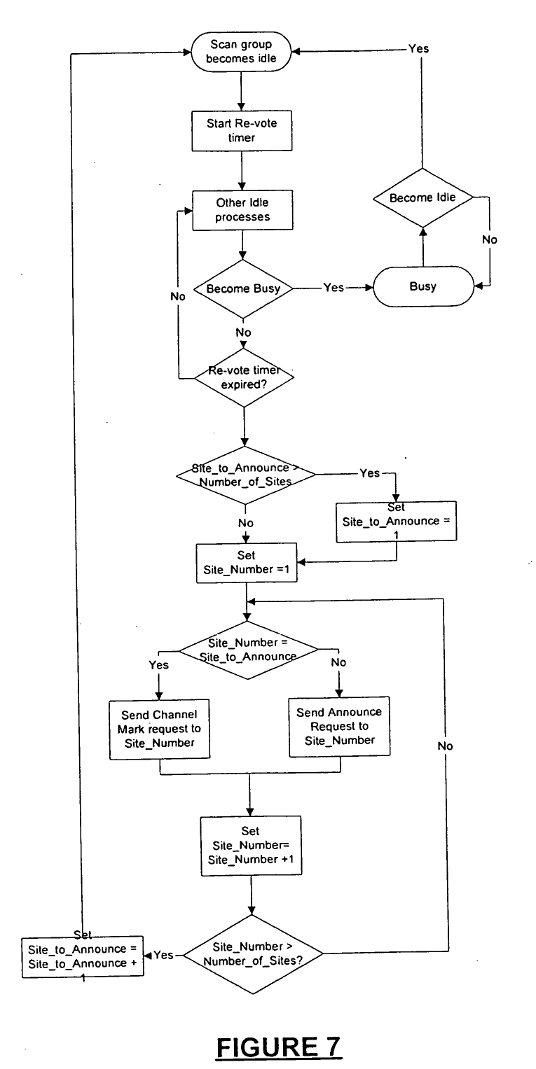

FIG. 7 outlines the operation of a central controller when coordinating transmission of a scan assist process such as shown in FIG. 2. The controller first determines that a base station involved with a call has become idle during the call. Initially the controller may instruct other prescribed idle processes within the group of stations involved in the call. The call may resume during this period, otherwise the controller sends instructions to the stations involved in the call to commence the channel marking process. Only one station in the group can transmit the marking signal while the others transmit announcement messages containing information about the station transmitting the marking-signal. The controller rotates selection of the station that is instructed to commence the marking signal so that the scan assist process is carried out as uniformly as possible within the network.

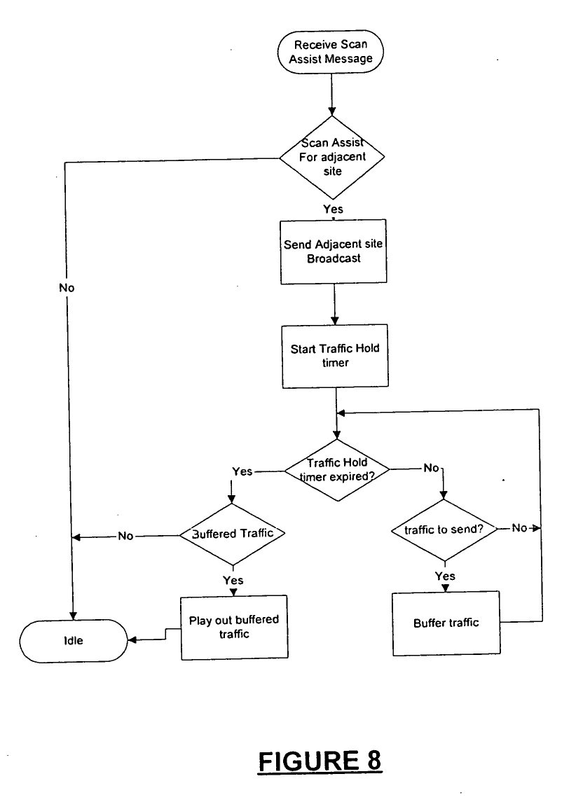

FIG. 8 outlines operation a base station receiving a scan assist message, either from another base station such as in FIG. 1, or from a central controller as in FIG. 2 for example. If the station is adjacent to the station that is required to transmit the marking signal, then the station transmits announcement messages about the station transmitting the marking signal. Meanwhile traffic received by the station is buffered for the duration of the scan assist process and sent once the process is complete. If the station is not adjacent the station that is required to transmit the marking signal, then the station typically transmits a busy signal during the scan assist process. Other scan assist messages received during the current process are ignored while the first process is carried out.

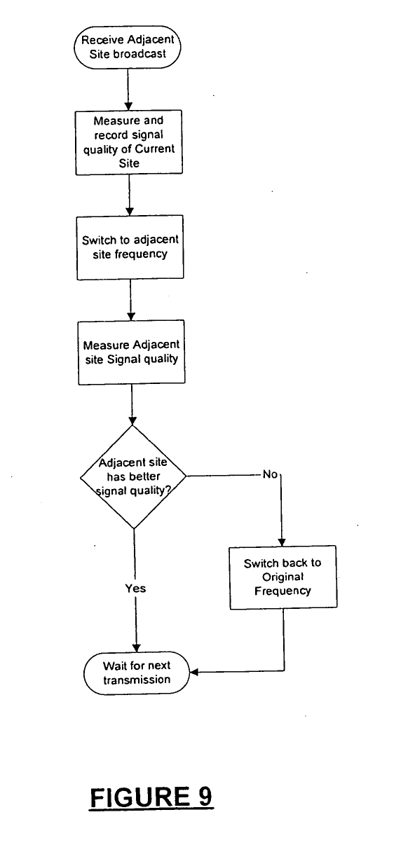

FIG. 9 outlines operation of a mobile unit receiving service from a base station upon receiving an announcement from the current station that an adjacent station is transmitting a channel marking signal. Such as mobile unit G in FIG. 1 or 2 receiving service from station B and receiving an announcement about station A. The unit first measures one or more characteristics of the announcement signal to enable a comparison with the signal of the marking station. The unit then switches to the frequency of the marking station using information provided in the announcement signal, and repeats the measurements. An assessment is then made by way of a comparison between the quality of the two signals and the unit either remains on the frequency of the marking station or returns to the original frequency. The assessment may be based on signal strength, noise or error rate for example.

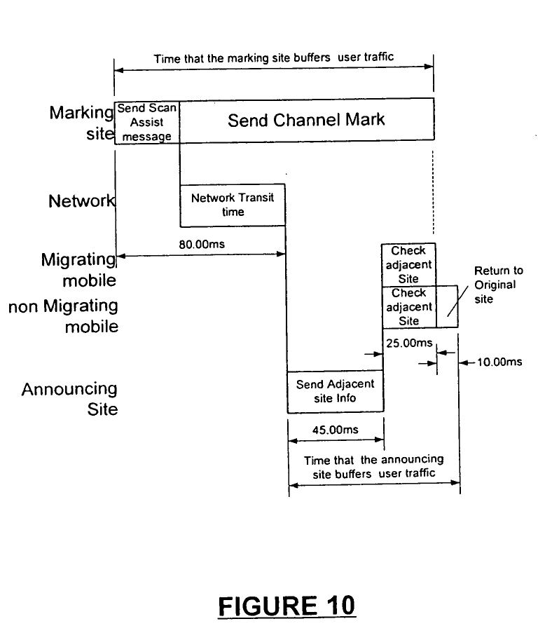

FIG. 10 gives an example of event and message timing in a network having distributed control of the scan assist process. The overall time required for the process includes the initial transmission of the scan assist message by the marking station followed by the duration of the marking signal. The marking station buffers user traffic throughout this period. During transmission of the marking signal the network must deliver the scan assist message to other stations, those stations which are adjacent to the marking station must transmit their announcements about the marking station, and the mobile units served by the adjacent stations must carry out their assessment process.

The base stations and mobile units that may operate in networks of the present kind have a range of generally standard constructions including microprocessor controller and memory, transmitter and receiver components, antenna and power supply. The scan assist process is generally carried out by the microprocessor following instructions stored in the memory.

1. A method of assisting movement of a mobile unit in a radio network, including:
transmitting a first assist signal from a first base station in the network,
transmitting a second assist signal from a second base station adjacent the first station, containing information about the first base station,
assessing the first and second assist signals at a mobile unit that is served by the second station, and
continuing service for the mobile unit without change of base station, or changing service for the unit from the second to the first station, in accord with the assessment.

2. A method according to claim 1 further including:
transmitting multiple second assist signals from respective second base stations adjacent the first base station, each containing information about the first station,
assessing the first and second assist signals at mobile units that are served by respective second base stations, and
continuing service for each of the mobile units without change of base station, or changing service for each unit from the respective second station to the first station, in accord with the respective assessment.

3. A method according to claim 1 further including:
determining that the first base station is idle before commencing transmission of the first assist signal.

4. A method according to claim 1 further including:
buffering other transmissions from the first and second base stations while transmitting the first and second assist signals.

5. A method according to claim 1 wherein the mobile unit is participating in a call with a group of other mobile units served by a multicast system in the network.

6. A method according to claim 5 further including:
monitoring radio traffic flow at each base station involved in the call, and
selecting the first base station as a station that has become idle.

7. A method according to claim 5 further including:
buffering transmissions received from each mobile station in the group while the first base station is transmitting the first assist signal.

8. A method according to claim 1 further including:
transmitting a commencement signal to each base station adjacent to the first base station before transmitting the first assist signal from the first base station, and transmitting a second assist signal from each base station adjacent to the first base station for a predetermined period of time after receipt of the commencement signal.

9. A method according to claim 1 further including:
monitoring all group calls between mobile units in the network, and selecting one or more first base stations for transmission of a respective assist signal according to radio traffic flow in the groups.

10. A method according to claim 1 wherein the mobile unit assesses the assist signals using error rate, signal strength or noise characteristics.

11. A method of moving a mobile unit between base sites during a group call in a radio network, including:
receiving an assist signal from a base station at a base site currently serving the mobile unit,
determining from the assist signal another base station in a base site adjacent to the site currently serving the mobile unit, receiving an assist signal from the other base station in the adjacent base site, and comparing the assist signals to determine whether or not to continue service from the current base site or to switch service to the adjacent base site.

12. A method according to claim 11 further including:
comparing the assist signals using error rate, signal strength or noise characteristics of the signals.

13. A radio network including:
a plurality of base stations each located at a respective base site, and
a central controller that coordinates multicast group calls among mobile units that are served by the stations, and assists movement of the units between base sites during calls, wherein the controller monitors radio traffic flows at each base station serving a common group call,
instructs transmission of a first assist signal by a first base station that serves the call, and instructs transmission of one or more second assist signals by respective second stations that serve the call and are in sites adjacent the first station.

14. A radio network according to claim 13 wherein the controller instructs the first and second base stations to transmit the first and second assist signals for a predetermined period of time after the first station becomes idle during the call.

15. A radio network according to claim 13 wherein mobile units receiving service from each of the second stations assess both the first assist signal and their respective second assist signals to determine whether or not to transfer service from the respective second station to the first station.

16. A base site in a radio network, including:
a base station that provides group call services to mobile units located within the site, and
a controller that monitors traffic flow through the base station and assists movement of mobile units into the site during a group call,
wherein the controller instructs the base station to transmit a first assist signal when the station becomes idle, and
instructs base stations serving the call at adjacent base sites to transmit respective second assist signals simultaneously with the first assist signal.

17. A base site according to claim 16 wherein the controller assists movement of mobile units into the site during the group call by instructing the base station to transmit a second assist signal when requested by a controller at an adjacent site.
